(19) United States
(12) Patent Application Publication
(10) Pub. No.: US 2010/0287729 A1
(43) Pub. Date: Nov. 18, 2010

(54) Hydraulic Door Closer

(75) Inventors: Zhigao Jin, Linhai City (CN); Xinhua Zhou, Linhai City (CN)

Correspondence Address: JANSSON SHUPE & MUNGER LTD., 245 MAIN STREET, RACINE, WI, 53403, US

(73) Assignee: ZHEIJANG MOER HARDWARE MFG CO., LTD., Linhai City (CN)

(21) Appl. No.: 12/717,613

(22) Filed: Mar. 4, 2010

(30) Foreign Application Priority Data
May 15, 2009 (CN) 2009203031951

(51) Int. Cl. E05F 3/10; E05F 1/10

(52) U.S. Cl. 16/52; 16/72

(57) ABSTRACT

A hydraulic door closer including an elongated housing, a connection rod extending into the housing, a piston secured at an inner end of the connection rod within the housing and a spring positioned within the housing about the connection rod. A throttle valve and a check valve are formed in the piston and define a throttle-valve fluid passage and a check-valve fluid passage, respectively. Both fluid passages are configured to be open for passing a fluid through the valves and closed to stop the fluid flow. The check-valve fluid passage is larger than the throttle-valve fluid passage and is closed during door closing for restricted fluid flow slowing the door motion. A stopping/holding mechanism includes a piston groove, a rod groove and a positioning pin disposed between the piston and the connection rod. The piston groove is defined by the piston for retaining the entire positioning pin during door opening/closing motion. The rod groove is defined by the connection rod to receive a portion of the positioning pin when both grooves are moved into alignment to close both valves and block the fluid flow between the chambers to hold the door open.

### CROSS REFERENCE TO RELATED APPLICATION

This application claims priority based on Chinese Patent Application No. 2009203031951, filed on May 15, 2009.

### FIELD OF THE INVENTION

The present invention relates to the field of door closers. In particular, to door closers of the type including a hydraulic damper.

### BACKGROUND OF THE INVENTION

A door closer is a device that allows a door to slowly close automatically. In situations when the door is blown open by wind, the presence of the door closer can effectively lower the impacting sound of the door being shut closing and, to some degree, protect the door.

One prior door closer is disclosed in a Chinese Patent Application No. 20061026679.4. Such prior door closer is of the type which has a thin integrated enclosure which is designed to have a sealer with a cylinder hole on at least one of its sides. A piston is connected to a compressing spring and positioned in the cylinder hole. The piston has a gear with a drive pinion on a drive shaft which is in a block-shaped shaft housing. The shaft housing is supported on two opposite sides of the enclosure with a bearing and is also sealed with a bearing housing through a sealing system. The drive shaft extends from the two housings such that the drive shaft can be connected to a connection rod or a drive arm. The enclosure has a circumferential area when view from one end. Such circumferential area forms a beginning at a posterior wall of the enclosure and an end at a front surface. The front surface is configured to extend parallel to the posterior wall. In addition, the enclosure has a protruding fixing knob and the posterior wall has a fixing hole on its side.

Such prior door closers have structures which are difficult to assemble, are expensive to manufacture, are difficult to use and are not-stable due to their complicated structure.

### OBJECTS OF THE INVENTION

It is an object of the invention to provide an improved door closer which overcomes the problems and shortcomings of the prior art, including those referred to above.

Another object of the invention is to provide an improved hydraulic door closer which is of a simple structure.

Another object of the invention is to provide an improved hydraulic door closer which is easy to assemble.

Still another object of the invention is to provide an improved hydraulic door closer which has a low production cost.

Yet another object of the invention is to provide an improved hydraulic door closer which allows for retention of a door at any desired angle or position in its path.

How these and other objects are accomplished will become apparent from the following description and the drawings.

### SUMMARY OF THE INVENTION

The present invention relates to a hydraulic door closer of the type including an elongated housing having a closed end and an opposite apertured end which defines an aperture therethrough. A connection rod extends through the aperture into the housing. A piston is secured at an inner end of the connection rod within the housing. A spring is positioned within the housing about the connection rod and extends between the apertured end and the piston. The piston divides the housing into a closed-end chamber and an apertured-end chamber. An external part or portion of the connection rod extends outside the housing.

The door closer disclosed herein includes a throttle valve and a check valve. The throttle valve is formed in the piston and defines a throttle-valve fluid passage which is configured to be open for passing a fluid between the chambers and closed to isolate the chambers. The check valve is formed in the piston and defines a check-valve fluid passage between the chambers. The check-valve fluid passage is larger than the throttle-valve fluid passage. It is highly preferred that, during door opening, both valves are open for fluid passage therethrough while, during door closing, the check valve is closed for restricted fluid flow only through the throttle valve to slow the door motion. As a result, the door closer allows the door to close slowly with the damping action of hydraulic fluid or hydraulic oil which lowers the impact sound in closing of the panel to effectively protect the panel.

Preferred embodiments of the inventive door closer have a stopping/holding mechanism. The stopping/holding mechanism includes a piston groove, a rod groove and a positioning pin disposed between the piston and the connection rod. The piston groove is formed in the piston for retaining the entire positioning pin during door opening/closing motion. The rod groove is formed in the connection rod and is configured to receive a portion of the positioning pin. The piston groove and the rod groove form limit grooves which facilitate holding of the door in the desired position. The door stops when the piston groove and the rod groove are moved into alignment with each other. Specifically, door movement stops when preferably approximately one-half of the positioning pin is within the rod groove and the other half is within the piston groove to retain the grooves in alignment. Such action closes both the check valve and the throttle valve and blocks the fluid flow between the chambers, thus stopping the movement of the door and holding the door at the desired position.

In some preferred embodiments, the piston includes a valve body and a spring-supporting portion. Such structure facilitates placement of the throttle and check valves by using their respective structures and to simplify the overall structure of the door closer. The inner end of the connection rod extends through the spring-supporting portion. The check valve is preferably formed in the valve body. The throttle valve is preferably formed between the valve body and the spring-supporting portion.

In one preferred embodiment, the piston groove of the stopping/holding mechanism is formed in the spring-supporting portion of the piston.

In some preferred embodiments, a central portion of the valve body defines a through throttle bore which connects the closed-end and apertured-end chambers of the housing. The throttle bore preferably includes a cone-shaped end cavity near the spring-supporting portion of the piston. The connection rod preferably includes a cone-shaped rod-section at its inner end which extends through the throttle bore. The inner end of the connection rod preferably cooperates with the throttle bore to form the throttle-valve passage. The flow of hydraulic oil can be cut-off or stopped at the throttle valve through the cooperation between the cone-shaped rod-section and the cone-shaped end cavity to hold the door closer at a certain position with the door panel being partially open.

When it is necessary to stop the door in a partially open position during closing or opening of the door, the user provides a slight push in the closing direction on the door itself. The cooperation of the hydraulic sealing between the cone-shaped end cavity with the cone-shaped rod-section will close the throttle valve and stop the flow of hydraulic oil. The interaction between the limit grooves and the positioning pin ensures that the throttle valve reliably cuts the hydraulic-oil flow to keep the door panel stable at the desired opened position. This facilitates holding of the door partially open when necessary. To close the door, the user just needs to push the door panel slightly in the opening direction.

The inner end of the connection rod preferably includes a threaded portion connected to a regulating nut. The cone-shaped end cavity of the throttle bore is between the regulating nut and the cone-shaped rod-section of the connection rod. It is preferred that the throttle bore includes a nut-receiving cavity which is opposite to the cone-shaped end cavity. The regulating nut may be positioned within the nut-receiving cavity. The axial position of the regulating nut on the connection rod may be changed by rotating the regulating nut to adjust the closing speed of the door closer by changing the relative axial position between the cone-shaped end cavity of the throttle passage and the cone-shaped rod-section on the connection rod. The placement of the regulating nut in the nut-receiving cavity of the throttle bore substantially improves structural compactness of the piston to ensure stability of the regulating nut on the axial position of the connection rod.

The check valve preferably includes the check-valve passage and a plug configured for closing the passage to fluid flow through the check valve. The check-valve passage is preferably formed by a check-valve cavity and a side passage. The check-valve cavity includes a closeable side and is preferably formed within the valve body such that the check-valve cavity is in communication with both the closed-end chamber and the apertured-end chamber. The side passage is preferably formed between the valve body and an inner surface of the housing such that the inner surface of the housing may form a part of the check valve. The side passage is in communication with the check-valve cavity. The plug is preferably positioned within the check-valve cavity for sliding against its closeable side to block the flow of the fluid through the check valve. It is preferred that the plug has a substantially round cross-section and that the closeable side of the check-valve cavity has an arch-shaped surface.

In preferred embodiments, the check-valve cavity is a sliding cavity within the valve body, and the plug is a slider positioned within the cavity. The end of the cavity extends into the leading side of a main flow path. The slider, sliding cavity, and the inner side of the housing form the check valve. The slider and the sliding cavity form the main component of the check valve, which simplifies the structure of the check valve and facilitates the placement. The above-mentioned slider may be a ball bearing, and the leading side is arc-shaped. The space between the ball-bearing-shaped slider and the arc preferably cooperate for improved hydraulic sealing to improve the operation stability of the check valve.

In operation, the two chambers of the housing should be fully filled with a hydraulic oil. The door closer is secured to a back side of the door panel through connection of one end of the housing, and the external end of the connection rod to the door frame. Opening of the door panel drives the connection rod and the piston within the housing. In the opening process, the spring is compressed and stores certain elastic potential. At such time, the check valve opens and the hydraulic oil flows between chambers of the housing. When the door panel receives the elastic potential released from the spring, such potential draws the piston in a reverse direction. Such piston movement results in the hydraulic oil also flowing back. Due to such flow, the check valve shuts closed such that the hydraulic oil flows only through the throttle valve. Because the throttle valve has the fluid passage which is of substantially small cross-section dimension, the hydraulic oil flows in a small volume and forms a resistance to the spring release. This controls the closing speed of the door panel.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a cross-sectional side view of the hydraulic door closer of the present invention.

FIG. 2 is an enlarged fragmental cross-sectional side view of the door closer of FIG. 1 illustrating a piston when of the door panel is being opened; the arrows showing the flowing direction of a hydraulic oil.

FIG. 3 is an enlarged fragmental cross-sectional side view of the door closer of FIG. 1 illustrating a piston when of the door panel closes; the arrows showing the flowing direction of a hydraulic oil.

FIG. 4 is an enlarged fragmental cross-sectional side view of the door closer of FIG. 1 illustrating a piston when the door panel is topped at a partially-open position.

FIG. 5 is a cross-sectional top view of the fully closed door equipped with the door closer of FIG. 1.

FIG. 6 is a cross-sectional top view of the fully opened door equipped with the door closer of FIG. 1.

FIG. 7 is a cross-sectional top view of the door equipped with the door closer of FIG. 1; the door being stopped in a partially open position.

### DETAILED DESCRIPTION OF PREFERRED EMBODIMENTS

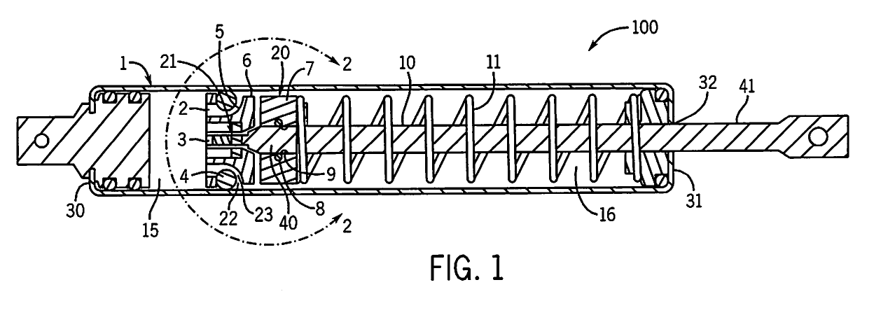

FIGS. 1-4 best illustrate a preferred embodiment of hydraulic door closer 100 which includes an elongated housing 1 having a closed end 30 and an opposite apertured end 31 which defines an aperture 32 therethrough. A connection rod 10 extends through aperture 32 into housing 1, a piston 20 secured at an inner end 40 of connection rod 10 within housing 1, and a spring 11 positioned within housing 1 about connection rod 10 and extending from apertured end 31 to piston 20. Piston 20 divides housing 1 into a closed-end chamber 15 and an apertured-end chamber 16. An external part 41 of connection rod 10 extends outside housing 1. Spring 11 is coupled within apertured-end chamber 16 around an external part 41 of connection rod 10, and the two ends of spring 11 act on the piston 20 and apertured end of housing 1, respectively.

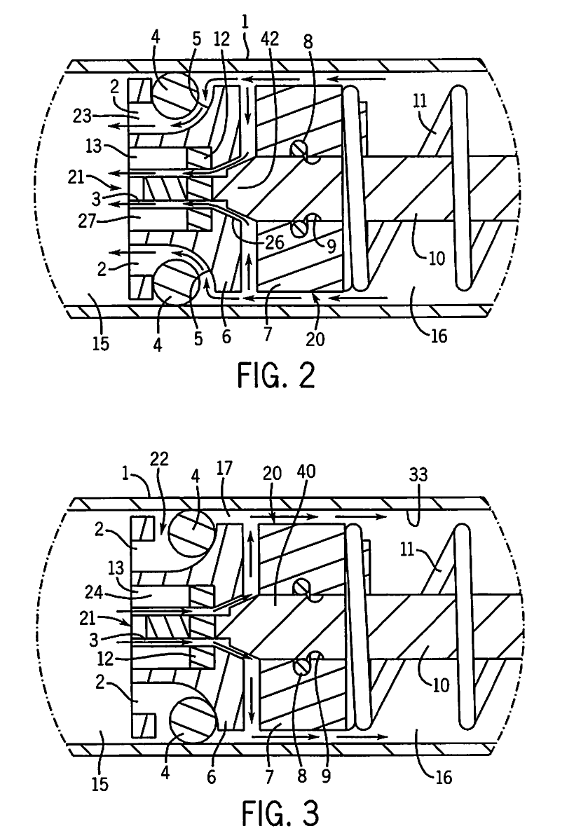

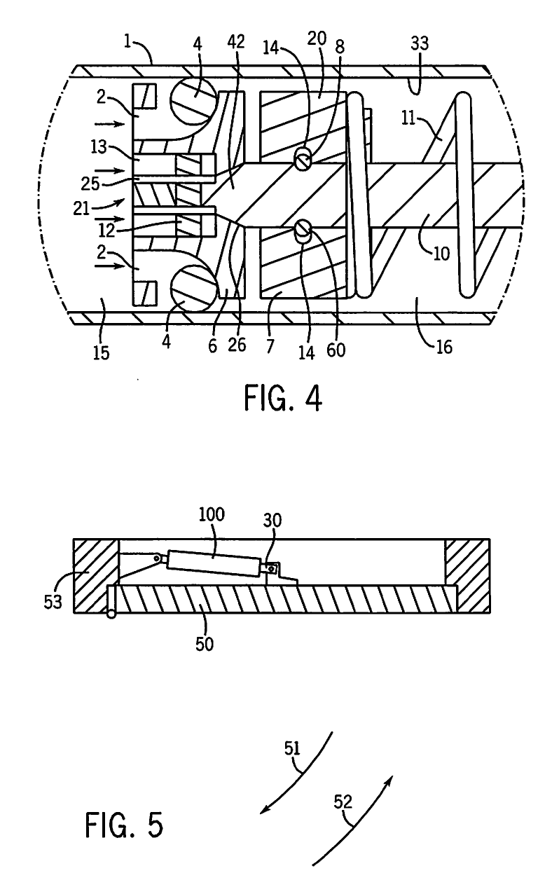

One preferred embodiment of door closer 100 includes a throttle valve 21 and a check valve 22. Throttle valve 21 is formed in piston 20 and defines a throttle-valve fluid passage 3 which is configured to be open (FIGS. 2 and 3) for passing a fluid between chambers 15 and 16 and closed (FIG. 4) to isolate chambers 15 and 16. Check valve 22 is formed in piston 20 and defines a check-valve fluid passage 23 between chambers 15 and 16. Check-valve fluid passage 23 has a greater cross-dimension than throttle-valve fluid passage 3. As shown in FIG. 2, when a door 50 is being opened in a direction of arrow 51 seen in FIGS. 5-7, both valves 21 and 22 are open for fluid passage therethrough. FIG. 3 shows that, during door closing in a direction of arrow 52 also seen in FIGS. 5-7, check valve 22 is closed such that the fluid flow is restricted to only smaller throttle valve 21 to slow the door motion. As a result, the door closer allows the door to close slowly with the damping action of hydraulic oil which lowers the impact sound in the panel closing to effectively protect the panel.

FIGS. 1-4 further show that door closer 100 has a stopping/holding mechanism 60. To enable door closer 100 to hold an open door or door panel 50 at a particular position, stopping/holding mechanism 60 is designed between spring-supporting portion 7 of piston 20 and connection rod 10. Stopping/holding mechanism 60 includes a piston groove 14, a rod groove 9 and a positioning pin 8 which is disposed between piston 20 and connection rod 10. Piston groove 14 and rod groove 9 are placed in adjacent sides of spring-supporting portion 7 and connection rod 10 such that pin positioning 8 can be clipped between grooves 9 and 14. The cross section of positioning pin 8 is a circle. Piston groove 14 and rod groove 9 both have a semicircle cross-section portion. As best seen in FIGS. 2, 3 and 4, piston groove 14 is formed in piston 20 for retaining entire positioning pin 8 during door-opening and door-closing motions. FIG. 4 best shows rod groove 9 formed in connection rod 10 and is configured to receive only a portion, preferably approximately one-half, of positioning pin 8. Piston and rod grooves 14 and 9 form limit grooves which facilitate holding of door 50 in the desired position shown in FIG. 7. As illustrated in FIG. 4, door 50 stops when, piston groove 14 and rod groove 9 are moved into alignment with each other such that approximately half of positioning pin 8 is within rod groove 9 and the other approximately half of positioning pin 8 is within piston groove 14 to retain the grooves in alignment. Such action closes both check valve 22 and throttle valve 21 and blocks the fluid flow between chambers 15 and 16. Such valve closure stops the movement of door 50 and holds the door at the desired position.

Piston 20 includes a valve body 6 and a spring-supporting portion 7. It is seen in FIGS. 1-4 that inner end 40 of connection rod 10 extends through spring-supporting portion 7 with one end of spring 11 being coupled to spring-supporting portion 7. Connection rod 10 is linked with valve body 6. Check valve 22 is formed in valve body 6. Throttle valve 21 is formed between valve body 6 and spring-supporting portion 7. Piston groove 14 of stopping/holding mechanism 60 is formed in spring-supporting portion 7 of piston 20.

A central portion 24 of valve body 6 defines a throttle bore 25 which connects closed-end chamber 15 and apertured-end chamber 16 of housing 1. Throttle bore 25 includes a cone-shaped end cavity 26 near spring-supporting portion 7 of piston 20. Connection rod 10 includes a cone-shaped rod-section 42 at its inner end 40 which extends through throttle bore 25. As further seen in FIGS. 2-4, inner end 40 of connection rod 10 cooperates with throttle bore 25 to form throttle-valve passage 3. The clearance between valve body 6 and spring-supporting portion 7 and the space between cone-shaped rod-section 42 of connection rod 10 and apertured-end chamber 16 of throttle bore 25 form throttle valve 21. The clearance between cone-shaped rod-section 42 of connection rod 10 and apertured-end chamber 16 of throttle bore 25 determines the flowing volume of throttle valve 21. This clearance is determined by regulating nut 12 connected to connection rod 10 by a threading. Concave nut-receiving cavity 27 is formed in valve body 6 opposite form spring-supporting portion 7. Regulating nut 12 is positioned in receiving cavity 27.

Inner end 40 of connection rod 10 includes a threaded portion which is connected to regulating nut 12. As seen in FIGS. 2-4, cone-shaped end cavity 26 of throttle bore 25 is between regulating nut 12 and cone-shaped rod-section 42 of connection rod 10. Throttle bore 25 also includes nut-receiving cavity 27 which is opposite to cone-shaped end cavity 26. Regulating nut 12 is positioned within nut-receiving cavity 27. The axial position of regulating nut 12 on connection rod 10 may be changed by rotating regulating nut 12 to adjust the closing speed of door closer 100 by changing the relative axial position between cone-shaped end cavity 26 of throttle passage 3 and cone-shaped rod-section 42 of connection rod 10. As seen in the FIGS. 1-4, the placement of regulating nut 12 in nut-receiving cavity 27 of throttle bore 25 substantially improves structural compactness of piston 20 and ensures stability of regulating nut 12 in the axial position of connection rod 10.

Check valve 22 includes check-valve passage 23 and a plug 4 configured for closing passage 23 to the fluid flow through check valve 22. Check-valve passage 23 is formed by a check-valve cavity 2 and a side passage 17. Check-valve cavity 2 includes a closeable side 5 and is formed within valve body 6 such that check-valve cavity 2 is in communication with both closed-end chamber 15 and apertured-end chamber 16. Check-valve cavity 2 has a curved configuration with the main flowing side extending to closeable side 5 near spring-supporting portion 7. Plug 4 is positioned inside check-valve cavity 2 for sliding movement therealong. When plug 4 approaches closeable side 5 and inner surface 33 of housing 1 under the driving of hydraulic oil, check valve 22 is closed for hydraulic-oil flow therethrough.

Side passage 17 is formed between valve body 6 and an inner surface 33 of housing 1 such that inner surface 33 forms a part of check valve 22. Side passage 17 is in communication with check-valve cavity 2. Plug 4 is positioned within check-valve cavity 2 for sliding against its closeable side 5 to block the fluid flow through check valve 22. Plug 4 has a substantially round cross-section and closeable side 5 of check-valve cavity 2 has an arch-shaped surface.

FIGS. 2-4 show that, in the actual operation, two chambers 15 and 16 of housing 1 are fully filled with a hydraulic oil. Door closer 100 is secured to a back side of a door frame 53 with external end 41 of connection rod 10 and to door panel 50 with closed end 30 of housing 1.

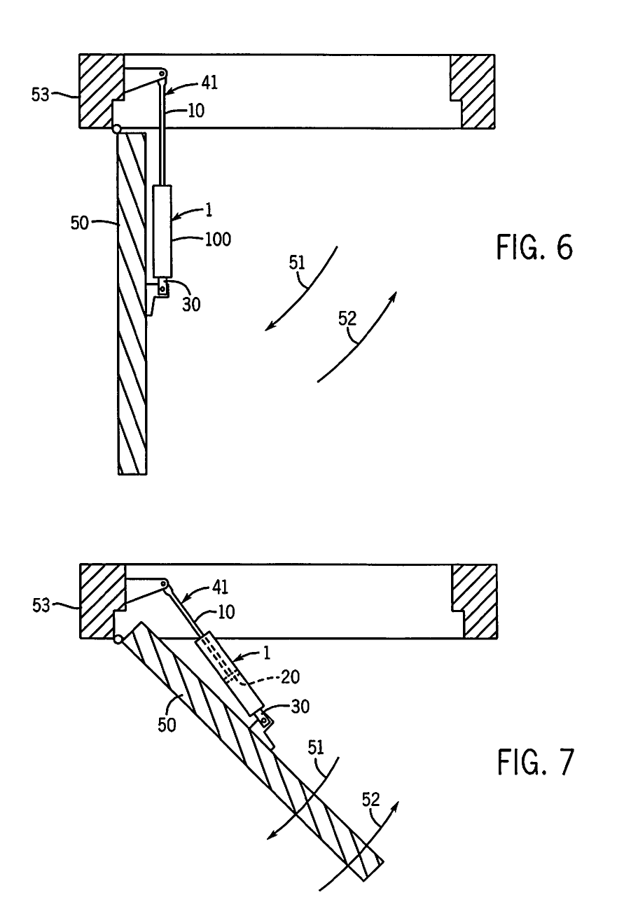

As shown in FIG. 2, the opening of door panel 50 drives connection rod 10 and piston 20. In opening action of door panel 50 also seen in FIGS. 6 and 7, connection rod 10 extends out of housing 1 through apertured end 31. Such motion moves spring-supporting portion 7 under the limit of regulating nut 12 and valve body 6 of piston 20 toward apertured end of housing 1. At such time, the position of housing 1 remains unchanged. In the opening process, spring 11 is compressed to accumulate certain potential energy to provide closing drive for closing the door after door panel 50 is opened. At such time, the hydraulic-oil flow pushes plug 4 away from closeable side 5 and opens check valve 22 for the hydraulic-oil flow from apertured-end chamber 16 to closed-end chamber 15 within housing 1. In this process, the flowing volume of hydraulic oil is high and the oil flows smoothly. The resistance to connection rod 10 is small.

FIG. 3 shows how for closing door 50, spring 11 releases the elastic potential which draws piston 20 in a reverse direction, i.e., toward closed-end chamber 15. This results forces the hydraulic oil to flow back from closed-end chamber 15 to apertured-end chamber 16. Such hydraulic-oil flow pushes plug 4 against closeable side 5 and shuts check valve 22 closed and keep it tight with closeable side 5 and inner surface 33 of housing 1 so as to cut the flowing of hydraulic oil from closed-end chamber 15 to apertured-end chamber 16 through check valve 22. Now, the hydraulic oil can flow only through throttle valve 21 which has throttle fluid passage 3 with a substantially smaller cross dimension than check-valve fluid passage 23. The hydraulic oil flows through throttle passage 3 in a small volume which forms a resistance to the spring release. In the flowing of the hydraulic oil, the flowing volume is small because of the small flowing diameter of throttle valve 21. As a result, the speed at which spring 11 releases its potential energy is limited and adds damping of the closing action of door closer 100, thus making door 50 close slowly. By rotating regulating nut 12, the axial position between valve body 6 and connection rod 10 is adjusted to change the clearance between cone-shaped end-cavity of throttle bore 25 and cone-shaped rod section of connection rod 10. Therefore, the closing speed of door panel 50 under the action of door closer 100 can be regulated.

To achieve stopping and holding of door 50 in a partially-open position during closing or opening of door 50, one needs to just slightly push door 50 in closing direction 52. When the action is made, relative axial motion will occur between connection rod 10 and valve body 6. Cone-shaped rod portion 42 of connection rod 10 will close cone-shaped end-cavity 26 of throttle bore 25 to cut the flow of the hydraulic oil through throttle valve 21. Such action will move rod groove 9 and piston groove 14 into alignment and, as shown in FIG. 4, cone-shaped rod-section 42 is pushed into a tight engagement with cone-shaped end cavity 26 to cut the flow of hydraulic oil through throttle valve 21. Such hydraulic sealing between cone-shaped end cavity 26 and the cone-shaped rod-section 42 closes throttle valve 21 and stops the flow of hydraulic oil therethrough. At this time, positioning pin 8 will clip into piston groove 14 and rod groove 9, which can keep certain axial connection stability between connection rod 10 and piston 20 to overcome the bounce of spring 11 and keep the door panel at a certain opening or open position. The interaction between limit grooves 9 and 14 and positioning pin 8 ensures that throttle valve 21 reliably cuts the hydraulic-oil flow maintaining hydraulic-oil equilibrium between chambers 15 and 16, to keep the door panel stable. Since spring 11 continues to exert the stored compression energy, check valve 22 is closed in a similar fashion as during closing of door 50. As a result, the spring pressure from chamber 16 comes into balance or equilibrium with the fluid pressure from chamber 15, all of which results in stopping of the piston movement, thus stopping and holding door 50 at a partially-open position. This facilitates holding of door 50 partially open when necessary.

To close door panel 50 held at a certain opening position, one just needs to push door 50 slightly in the opening direction 51. Cone-shaped rod section 42 will retreat from cone-shaped end cavity 26 to form a clearance for the hydraulic oil to flow through. At the same time, positioning pin 8 will receive a shearing force under which it can be fully pushed back into piston groove 14 of spring supporting portion 7. In this way, the hydraulic oil compressed in closed-end chamber 15 can flow back into apertured-end chamber 16 through throttle valve 21. Piston 7 under the action of spring 11 moves toward closed end 30 to close door 50.

To continue opening door 50 when it is held partially open, one just needs to open door 50 directly without doing any other actions.

Reference throughout this specification to “one embodiment,” “an embodiment,” “a preferred embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

While the present invention has been described in connection with certain exemplary or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

1. In a hydraulic door closer of the type including (a) an elongated housing having a closed end and an opposite apertured end which defines an aperture therethrough, (b) a connection rod extending through the aperture into the housing, (c) a piston secured at an inner end of the connection rod within the housing and dividing the housing into a closed-end chamber and an apertured-end chamber, and (d) a spring positioned within the housing about the connection rod and extending from the apertured end to the piston, the improvement comprising
the piston including:
a throttle valve defining a throttle-valve fluid passage configured to be open for passing a fluid between the chambers and closed to isolate the chambers; and
a check valve defining a check-valve fluid passage between the chambers, the check-valve fluid passage being larger than the throttle-valve fluid passage,
whereby both valves are open for fluid passage therethrough during door opening while the check valve is closed during door closing for restricted fluid flow slowing the door motion.

2. The hydraulic door closer of claim 1 further including a stopping/holding mechanism comprising:
a positioning pin disposed between the piston and the connection rod;
a piston groove defined by the piston for retaining the entire positioning pin during door opening/closing motion; and
a rod groove defined by the connection rod and configured to receive a portion of the positioning pin,
whereby to stop and hold the door, the piston groove and the rood groove are moved into alignment to close both check and throttle valves and block the fluid flow between the chambers.

3. The hydraulic door closer of claim 1 wherein:
the piston includes a valve body and a spring-supporting portion, the inner end of the connection rod extending through the spring-supporting portion;
the check valve is formed in the valve body; and
the throttle valve is formed between the valve body and the spring-supporting portion.

4. The hydraulic door closer of claim 3 further including a stopping/holding mechanism comprising:
a positioning pin disposed between the piston and the connection rod;
a piston groove defined by the piston for retaining the entire positioning pin during door opening/closing motion; and
a rod groove defined by the connection rod and configured to receive a portion of the positioning pin,
whereby to stop and hold the door, the piston groove and the rood groove are moved into alignment to close both the check valve and the throttle valve and block the fluid flow between the chambers.

5. The hydraulic door closer of claim 4 wherein the piston groove is formed in the spring-supporting portion of the piston.

6. The hydraulic door closer of claim 3 wherein:
a central portion of the valve body defines a through throttle bore with a cone-shaped end cavity; and
the connection rod includes a cone-shaped rod-section at its inner end which extends through the throttle bore and cooperates therewith to form the throttle-valve passage.

7. The hydraulic door closer of claim 6 further including a stopping/holding mechanism comprising:
a positioning pin disposed between the piston and the connection rod;
a piston groove defined by the piston for retaining the entire positioning pin during door opening/closing motion; and
a rod groove defined by the connection rod and configured to receive a portion of the positioning pin,
whereby to stop and hold the door the piston groove and the rood groove are moved into alignment to close both the check valve and the throttle valve and block the fluid flow between the chambers.

8. The hydraulic door closer of claim 7 wherein the piston groove is formed in the spring-supporting portion of the piston.

9. The hydraulic door closer of claim 3 wherein the check valve is formed by:
the check-valve passage including:
a check-valve cavity having a closeable side and formed within the valve body for communication with both the closed-end chamber and the apertured-end chamber; and
a side passage between the valve body and an inner surface of the housing and in communication with the check-valve cavity; and
a plug positioned within the check-valve cavity for sliding against its closeable side to block the fluid flow through the check valve.

10. The hydraulic door closer of claim 9 wherein:
a central portion of the valve body defines a through throttle bore including a cone-shaped end cavity; and
the connection rod includes a cone-shaped rod-section at its inner end which extends through the throttle bore and cooperates therewith to form the throttle-valve passage.

11. The hydraulic door closer of claim 9 wherein the plug has a substantially round cross-section and the closeable side has an arch-shaped surface.

12. The hydraulic door closer of claim 11 wherein:
a central portion of the valve body defines a through throttle bore including a cone-shaped end cavity; and
the connection rod includes a cone-shaped rod-section at its inner end which extends through the throttle bore and cooperates therewith to form the throttle-valve passage.

13. The hydraulic door closer of claim 12 wherein:
the inner end of the connection rod includes a threaded portion connected to a regulating nut;
the cone-shaped end cavity of the throttle bore is between the regulating nut and the cone-shaped rod-section of the connection rod.

14. The hydraulic door closer of claim 13 wherein the throttle bore includes a nut-receiving cavity opposite the cone-shaped end cavity, the regulating nut being positioned within the nut-receiving cavity.

15. The hydraulic door closer of claim 9 further including a stopping/holding mechanism comprising:
a positioning pin disposed between the piston and the connection rod;
a piston groove defined by the piston for retaining the entire positioning pin during door opening/closing motion; and
a rod groove defined by the connection rod and configured to receive a portion of the positioning pin,
whereby to stop and hold the door the piston groove and the rood groove are moved into alignment to close both check and throttle valves and block the fluid flow between the chambers.

16. The hydraulic door closer of claim 15 wherein the piston groove is formed in the spring-supporting portion of the piston.
